(19) United States
(12) Patent Application Publication
(10) Pub. No.: US 2026/0169229 A1
(43) Pub. Date: Jun. 18, 2026

(54) SHUTTERED FIBER OPTIC ADAPTORS

(71) Applicant: AFL Telecommunications LLC, Duncan, SC (US)

(72) Inventors: Soma Shekar Gandla, Milton Keynes (GB); Asher Leong Raven, Milton Keynes (GB)

(21) Appl. No.: 19/123,995

(22) PCT Filed: Sep. 19, 2023
(86) PCT No.: PCT/US2023/033100

§ 371 Date: Apr. 24, 2025

Related U.S. Application Data
(60) Provisional application No. 63/421,493, filed on Nov. 1, 2022.

(51) Int. Cl. G02B 6/38

(52) U.S. Cl. CPC G02B 6/3825; G02B 6/3845; G02B 6/3874

(57) ABSTRACT

Adapters and methods and systems utilizing adapters are provided. An adapter includes a housing defining a pair of ports configured to optically couple together a first connector and a second connector, wherein the housing includes a first housing portion; and a second housing portion removably coupled to the first housing portion; a shutter coupled to the housing, wherein the shutter is movable between a closed position in which the first port is blocked and an open position in which the first port is accessible; and a biasing element biasing the shutter to the closed position, wherein a portion of at least one of the shutter and the biasing element is retained between the first and second housing portions.

### CROSS-REFERENCE TO RELATED APPLICATIONS

The present application claims priority to U.S. Provisional Patent Application 63/421,493 filed on Nov. 1, 2022, the disclosure of which is incorporated by reference herein in its entirety.

### FIELD

The present disclosure relates generally to fiber optic adaptors, and more particularly to improved shuttered adaptors.

### BACKGROUND

Fiber optic signals are transmitted through optical fibers between two or more endpoints. Optical fibers are connected together to form optical networks which interconnect a plurality of endpoints to allow for data transmission. Connecting optical fibers together can be performed using different techniques. However, the primary methods of connecting fibers together include splicing unterminated ends of the fibers together and coupling connectors to the ends and mating the connectors together.

For connectorized optical fibers, connectorized ends are typically mated together through an adapter. Prior to installation of a connectorized end in the adapter, the adapter is kept in a sealed configuration to prevent ingress of debris into the adapter. Ingress of debris might scratch one or more optical components associated with the adapter (or the later connected connector) and impede signal transmission. Sealing of the adapter was traditionally performed using a plug. The plug could be inserted into the adapter to close the adapter opening and prevent debris ingress. Prior to installing the connector, the plug would be removed and replaced by the connector.

Over time, the plug solution was replaced by shutter mechanisms integrated into the adapter. The shutters selectively closed the adapter until a connector was introduced therewith. However, current adapters incorporating internal shutter mechanisms have large footprints that are non-standard compliant in at least one orientation or dimensions. As a result, desired fiber densities cannot be achieved as compared to adapters without internal shutter mechanisms.

Accordingly, improved adapters are desired in the art. In particular, adapters which provide integrated shutter design without compromising space and fiber density would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, an adapter is provided. The adapter includes a housing defining a pair of ports configured to optically couple together a first connector and a second connector, wherein the housing comprises: a first housing portion; and a second housing portion removably coupled to the first housing portion; a shutter coupled to the housing, wherein the shutter is movable between a closed position in which the first port is blocked and an open position in which the first port is accessible; and a biasing element biasing the shutter to the closed position, wherein a portion of at least one of the shutter and the biasing element is retained between the first and second housing portions.

In accordance with another embodiment, an optical system is provided. The optical system includes a frame having a first side and a second side, the frame defining a receiving slot extending between the first side and the second side; and an adapter comprising: a housing defining a pair of ports including a first port and a second port; a shutter coupled to the housing, wherein the shutter is movable between a closed position in which the first port is blocked and an open position in which the first port is accessible; and a biasing element biasing the shutter to the closed position, wherein the adapter is installable into the receiving slot from the first side of the frame in a first orientation with the first port facing toward the frame during installation or a second orientation with the first port facing away from the frame during installation, and wherein the adapter is selectively securable in the receiving slot in both the first and second orientations.

In accordance with another embodiment, a method of coupling an adapter to a frame defining a receiving slot is included. The method includes aligning the adapter including a shutter with the receiving slot in a first orientation or a second orientation opposite the first orientation; and translating the adapter into the receiving slot until the adapter passes a locking position after which removal of the adapter from the receiving cutout requires an unlocking procedure.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a single-port adapter in accordance with embodiments of the present disclosure;

FIG. 2 is a perspective view of a two-port adapter in accordance with embodiments of the present disclosure;

FIG. 3 is a perspective view of a quad-port adapter in accordance with embodiments of the present disclosure;

FIG. 4 is an exploded view of a two-port adapter in accordance with embodiments of the present disclosure;

FIG. 5 is a perspective view of a sleeve portion of a ferrule alignment sleeve in accordance with embodiments of the present disclosure;

FIG. 6 is a bottom view of a portion of a housing of the adapter with the sleeve portion of FIG. 5 being installed in accordance with embodiments of the present disclosure;

FIG. 7 is a perspective view of a shutter assembly for the adapter in accordance with embodiments of the present disclosure;

FIG. 8 is a perspective view of a shutter for the shutter assembly in accordance with embodiments of the present disclosure;

FIG. 9 is a bottom view of the adapter in accordance with embodiments of the present disclosure;

FIG. 10 is a cross-sectional side view of the adapter as seen along Line A-A in FIG. 9 in accordance with embodiments of the present disclosure;

FIG. 11 is a cross-sectional side view of the adapter as seen along Line A-A in FIG. 9 in accordance with embodiments of the present disclosure;

FIG. 12 is a cross-sectional side view of the adapter as seen along Line A-A in FIG. 9 in accordance with embodiments of the present disclosure;

FIG. 13 is a perspective view of a biasing element in accordance with embodiments of the present disclosure;

FIG. 14 is a perspective view of an adapter in accordance with embodiments of the present disclosure;

FIG. 15 is a perspective view of a second housing portion of the adapter in accordance with embodiments of the present disclosure;

FIG. 16 is a perspective view of a second housing portion of the adapter in accordance with embodiments of the present disclosure;

FIG. 17 is a perspective view of an adapter in accordance with embodiments of the present disclosure;

FIG. 18 is a perspective view of an optical system including a frame and an adapter coupled to the frame in accordance with embodiments of the present disclosure; and

FIG. 19 is a side view of an optical system including a frame and an adapter coupled to the frame in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, adapters and systems and methods utilizing adapters described herein allow for optical coupling between two or more optical cables. The adapters can utilize shutters that close cable ports when no optical cable is present therein. The shutters can be biased to the closed position by a biasing element including a base and one or more fingers extending from the base. In certain instances, two or more fingers can share a common base. The shutters and associated biasing element(s) can be installed between first and second housing portions of a housing of the adapter to allow for quick installation. In an embodiment, the adapter can further include reversible installation hardware that allows an installation technician to reversibly install the adapter on a frame or other connection hardware, such as found at a fiber distribution hub, a data center, an in-field enclosure, or the like. Advantageously, adapters and systems and methods utilizing adapters described herein can permit easier operation and installation while also maintaining clean optical connections for optical coupling.

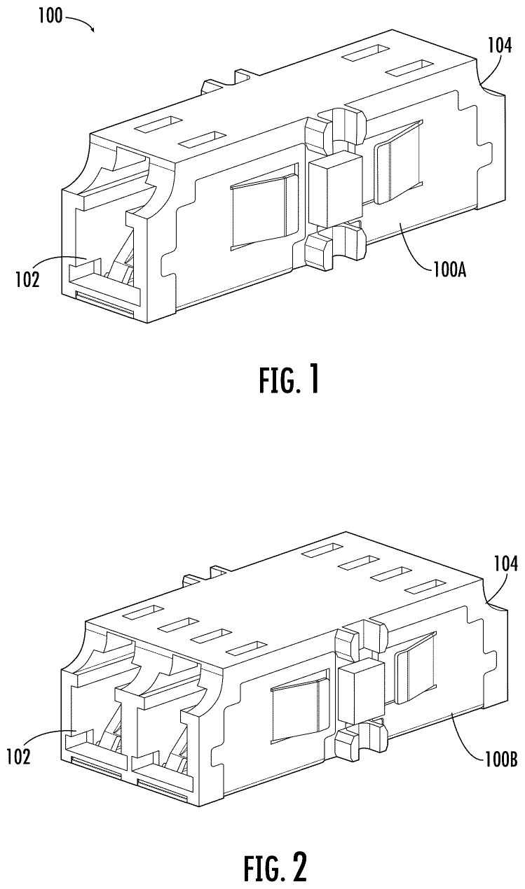

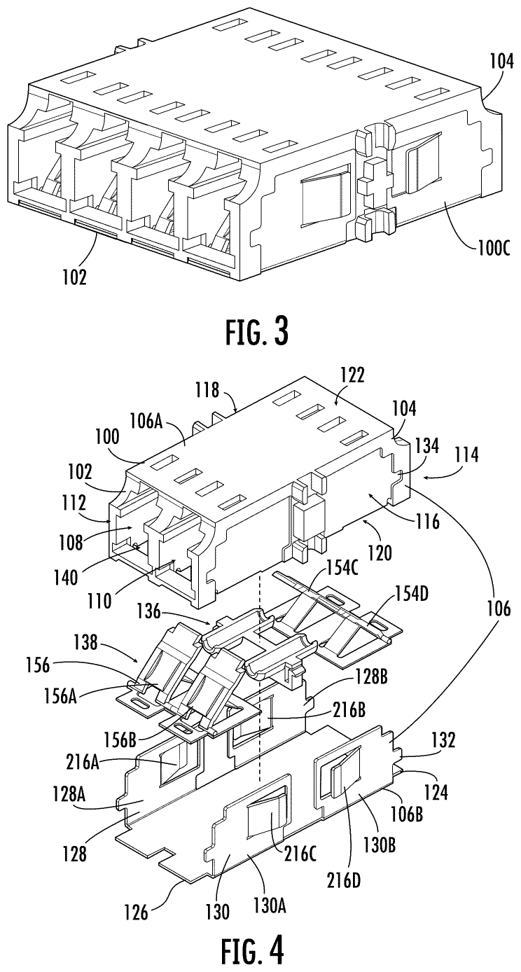

Referring now to the drawings, FIGS. 1 to 3 illustrate adapters 100A, 100B and 100C (collectively referred to hereinafter as adapters 100 unless indicated otherwise) in accordance with exemplary embodiments described herein. The adapter 100A illustrated in FIG. 1 is a single port adapter configured to optically couple a single pair of optical cables together. The adapter 100B illustrated in FIG. 2 is a two-port adapter configured to optically couple two pairs of optical cables together. The adapter 100C illustrated in FIG. 3 is a four-port adapter configured to optically couple four pairs of optical cables together. Other numbers of optical cables can be optically coupled together using a multi-port adapters 100, for example, with three (3) ports, five (5) ports, six (6) ports, seven (7) ports, etc. To optically couple optical cables together using the adapter 100, one of the optical cables is inserted into a first end 102 of the adapter 100 and another one of the optical cables is inserted into a second end 104 of the adapter 100. By aligning the ends of optical fibers within the optical cables with respect to one another such that the ends are in optical communication with one another, the optical cables are optically coupled together within the adapter 100 to permit transmission of optical signals between the two optical cables.

FIG. 4 illustrates an exploded view of the adapter 100 illustrated in FIG. 2 as seen in an accordance with an exemplary embodiment. The adapter 100 generally includes a housing 106. In some instances, the housing 106 is formed from a plurality of components, such as a first housing portion 106A and a second housing portion 106B.

The first housing portion 106A can be formed from a first material. By way of non-limiting example, the first material can include a plastic, such as a thermoplastic or a thermoset. One or more fillers may be included in the first material to increase one or more desirable characteristics thereof. In one or more instances, the first housing portion 106A can be formed using a molding technique, such as injection molding. In an embodiment, the first housing portion 106A can have a monolithic construction. For instance, the first housing portion 106A can be formed from a homogenous, single-piece material. In another embodiment, the first housing portion 106A can have a heterogeneous construction including, e.g., two or more regions or materials having different constructions or material compositions.

The second housing portion 106B can be formed from a second material. The second material can be different than the first material. By way of non-limiting example, the second material can include a metal. The metal can include, for example, sheet metal. The metal can include a spring metal configured to have an elastic property which permits the metal to rebound to an initial, desired position. By way of other non-limiting examples, the second material can include, e.g., an alloy, a plastic different from the first material, or the like. In yet other embodiments, the second material can be the same as the first material.

In an embodiment, the first housing portion 106A can define the first end 102 and the second end 104 of the adapter 100. In an embodiment, the first housing portion 106A includes a plurality of ports, such as a first port 108 and a second port 110. As described above, the adapter 100 can alternatively include a single port, or more than two ports, such as at least three ports, such as at least four ports, such as at least five ports, such as at least six ports, such as at least seven ports, etc. The first and second ports 108 and 110 can each be one of a pair of ports. Each pair of ports can include a port on the first end 102 of the adapter 100 and a port on the second end 104 of the adapter 100. For example, the first port 108 can have a complementary port (not illustrated) disposed on the second end 104 of the first housing portion 106A.

The pairs of ports can be used together to optically align two optical cables with respect to one another.

In an embodiment, the first housing portion 106A includes end walls or end surfaces 112 and 114 at the first and second ends 102 and 104, respectively. The end walls or end surfaces 112 and 114 can define entrances to the first and second ports 108 and 110. Extending between the end walls or end surfaces 112 and 114 are a first lateral side 116, a second lateral side 118, a bottom side 120, and a top side 122. The first and second lateral sides 116 and 118 can be separated by the bottom side and the top side 122. In an embodiment, the first and second lateral sides 116 and 118 can be substantially continuous, or continuous, surfaces substantially devoid of, or devoid of, openings extending into the first and second ports 108 and 110, respectively. In an embodiment, the top side 122 can be a substantially continuous, or continuous, surface substantially devoid of, or devoid of, openings extending into the first or second ports 108 or 110. In an embodiment, the bottom side 120 can define an open side of the adapter 100. At least one of the first or second ports 108 or 110 can be accessible through the open bottom side 120. In an embodiment, all of the ports of the adapter 100, i.e., the first and second ports 108 and 110, are accessible through the open bottom side 120. Accessibility through the open bottom side 120, as described in greater detail below, allows for one or more features of the adapter 100 to be installed within the ports in a direction perpendicular to a direction of insertion of the optical cables into the ports. Accessibility through the open bottom side 120 further increases the ease of assembly and repair of the adapter 100 and components associated therewith. It should be understood that the orientation of the adapter 100 can be changed such that the bottom side 120 becomes the top side 122 or one of the first and second lateral sides 116 or 118. Additionally, other configurations and arrangements can be made to alter the shape or functionality of the first housing portion 106A.

The second housing portion 106B can be coupled to the first housing portion 106A. In an embodiment, the second housing portion 106B may be selectively removable from the first housing portion 106A. In an embodiment, the second housing portion 106B can be interfaced with the first housing portion 106A by translating the second housing portion 106B towards the first housing portion 106A in a direction perpendicular to an insertion direction of an optical cable into at least one of the first or second ports 108 or 110. In an embodiment, the second housing portion 106B can be translated towards the bottom side 120 of the first housing portion 106A. The second housing portion 106B can cover at least a portion of, such as all of, the bottom side 120 and close the opening associated therewith.

The second housing portion 106B can generally include a body 124 having a bottom side 126 configured to cover the open bottom side 120 of the first housing portion 106A when the first and second housing portions 106A and 106B of the adapter are coupled together. The body 124 can further include a first lateral side 128 and a second lateral side 130. The first and second lateral sides 128 and 130 can both extend from the bottom side 126 in a similar orientation as one another. The orientation of the first and second lateral sides 128 and 130 can be generally perpendicular to an orientation of the bottom side 126. In certain instances, the first and second lateral sides 128 and 130 can be canted inwards, i.e., towards one another, such that the first and second lateral sides 128 and 130 form an interference fit with the first and second lateral sides 118 and 120 of the first housing portion 106A when the first and second housing portions 106A and 106B are coupled together.

In an embodiment, the first lateral side 128 can include a plurality of segments, such as a first segment 128A and a second segment 128B. The first and second segments 128A and 128B can both extend from the bottom side 126. The first and second segments 128A and 128B can be disconnected from one another such that the first and second segments 128A and 128B are independently conformable to the first lateral side 118 of the first housing portion 106A. The second lateral side 130 can similarly include a plurality of segments, such as a first segment 130A and a second segment 130B. The plurality of segments of the second lateral side 130 can include any one or more similar features as the plurality of segments of the first lateral side 128. Alternatively, the plurality of segments of the second lateral side 130 can include any one or more different features as compared to the plurality of segments of the first lateral side 128. The first and second segments 130A and 130B can be independently conformable to the second lateral side 120 of the first housing portion 106A.

In an embodiment, the second housing portion 106B can be disposed on at least one side of the first housing portion 106A when the second housing portion 106B is coupled with the first housing portion 106A. The at least one side can be the open bottom side 120 of the first housing portion 106A. In another embodiment, the second housing portion 106B can be disposed on at least two sides of the first housing portion 106A when the second housing portion 106B is coupled with the first housing portion 106A. The at least two sides can include the open bottom side 120 of the first housing portion 106A and at least one of the first or second lateral sides 116 or 118 of the first housing portion 106A. In another embodiment, the second housing portion 106B can be disposed on at least three sides of the first housing portion 106A when the second housing portion 106B is coupled with the first housing portion 106A. The at least three sides can include the open bottom side 120 of the first housing portion 106A, and the first and second lateral sides 116 and 118 of the first housing portion 106A. In another embodiment, the second housing portion 106B can be disposed at least partially on four sides of the first housing portion 106A when the second housing portion 106B is coupled with the first housing portion 106A (FIG. 14).

For example, referring to FIG. 14, the first and second lateral sides 116 and 118 and the bottom and top sides 120 and 122 of the first housing portion 106A can be at least partially abutted by, or disposed adjacent to, the second housing portion 106B. The first housing portion 106A may include one or more interfaces, such as one or more projections 212, which interface with one or more complementary interfaces, such as openings 214 in the second housing portion 106B to retain the first and second housing portions 106A and 106B together. It is noted that while the second housing portion 106B illustrated in FIG. 4 is formed from a single piece, i.e., monolithic construction, the second housing portion 106B can be formed from a plurality of pieces, such as at least two pieces, such as at least three pieces, as shown in FIG. 14.

Referring again to FIG. 4, the second housing portion 106B may include one or more features, such as one or more fingers 132, which engage with one or more complementary features, such as one or more recesses 134, of the first housing portion 106A to secure the first and second housing portions 106A and 106B together. As the second housing portion 106B reaches an engaged position with respect to the first housing portion 106A, the fingers 132 can interface with the recesses 134 to selectively couple the first and second housing portions 106A and 106B together. The second housing portion 106B may deform, e.g., flex outward, during an initial engagement step when the second housing portion 106B is introduced to the first housing portion 106A. When the second housing portion 106B reaches the proper engagement position, the second housing portion 106B can deform, e.g., flex inward, as the fingers 132 interface with the recesses 134. Such interfacing between the fingers 132 and the recesses 134 may occur as a snap. The snap between the fingers 132 and recesses 134 may provide an indication that engagement between the first and second housing portions 106A and 106B is complete. This indication may be, for example, in the form of tactile feedback, audible feedback, a visual indication, or any combination thereof. In some instances, the second housing portion 106B includes a plurality of fingers 132 and the first housing portion 106A includes a plurality of recesses 134 (such as shown in FIG. 4). In these embodiments, the fingers 132 and recesses 134 may be joined together simultaneously or at staggered intervals based on a relative angle between the first and second housing portions 106A and 106B when introduced together. In this regard, indication of proper engagement between the first and second housing portions 106A and 106B can occur simultaneously or at successive intervals.

The adapter 100 further includes one or more internal structures to support optical coupling between optical fibers introduced into the first and second ports 108 and 110 and complementary optical fibers introduced into the ports paired therewith on the second end 104 of the adapter 100. In an embodiment, the internal structure can interface with one or more portions of the first housing portion 106A, one or more portions of the second housing portion 106B, or both to secure the internal structure within an internal volume 140 of the adapter 100.

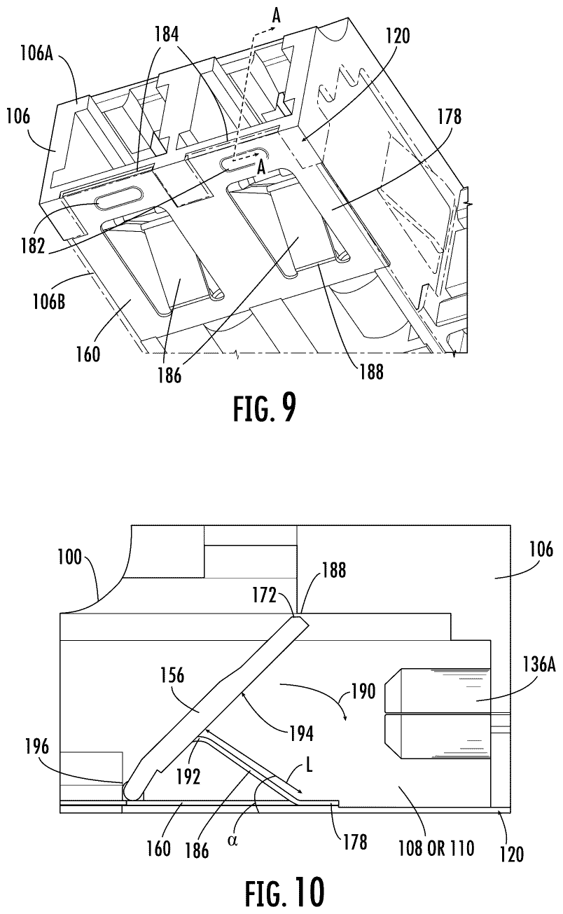

The internal structure can include, for example, a ferrule sleeve 136 configured to receive a ferrule of an optical fiber installed in the adapter 100. The ferrule sleeve 136 can be disposed between and optically couple together optical fibers introduced into the first and second ports 108 and 110 with complementary optical fibers introduced at the second end 104 of the adapter 100. In an embodiment, the ferrule sleeve 136 can include a single structure insertable into the internal volume 140 of the adapter 100. The single structure ferrule sleeve 136 can form the entirety of the ferrule sleeve 136 such that ferrules introduced to the ferrule sleeve 136 are supported only by the removable ferrule sleeve 136. In another embodiment, the ferrule sleeve 136 can include a plurality of components which together support the optical connection between optical fibers. For example, the ferrule sleeve 136 can include a first sleeve portion 136A (FIG. 9) integral with the housing 106, such as integral with the first housing portion 106A, and a second sleeve portion 136B (FIG. 4) which interfaces with the first sleeve portion 136A to form the ferrule sleeve 136.

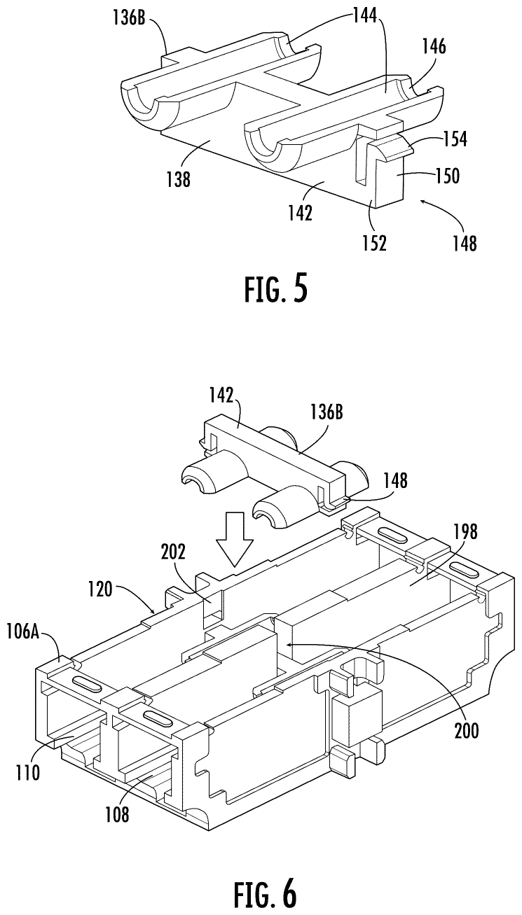

Referring to FIG. 5, the second sleeve portion 136B is illustrated in accordance with an exemplary embodiment. The second sleeve portion 136B can include a body 138 configurable to be inserted at least partially into the internal volume 140 (FIG. 4) of the adapter 100. The body 138 can generally include a sled 142 carrying one or more ferrule receiving portions 144 each configured to form at least a portion of a supporting interface for supporting ferrules inserted into the adapter 100. In an embodiment, the sled 142 and ferrule receiving portions 144 can be integrally formed, i.e., monolithic. In another embodiment, the ferrule receiving portions 144 can be connected to the sled 142. In an embodiment, the sled 142 can lie along a plane, or substantially along a plane, oriented perpendicular to a direction of insertion of the ferrules (not illustrated) into the ferrule receiving portions 144.

The number of ferrule receiving portions 144 on the body 138 can be the same as the number of ports in the adapter 100. Each ferrule receiving portion 144 can define a cradle, e.g., a hemi-circular profile, to receive and support a ferrule. Each ferrule receiving portion 144 may receive a plurality of ferrules, e.g., two ferrules, from opposite ends thereof inserted into the adapter 100 from the first and second ends 102 and 104. Lips 146 can provide supporting surfaces for the ferrules.

In an embodiment, the second sleeve portion 136B can be coupled to the housing 106 in a way to prevent relative movement of the second sleeve portion 136B relative to the housing 106. In one exemplary embodiment, the second sleeve portion 136B can be coupled to the first housing portion 106A (FIG. 6). For instance, the second sleeve portion 136B can include structures, such as one or more latches 148 interfaceable with the first housing portion 106A to selectively couple the second sleeve portion 136B to the first housing portion 106A. The latch 148 can include a projection 150 extending from the sled 142 and moveable relative to the sled 142, e.g., at a living hinge 152, such that an engagement structure 154 can be interfaced with a complementary receiving structure of the first housing portion 106A. The engagement structure 154 can be ramped to deflect the projection 150 during installation of the second sleeve portion 136B to allow for mating thereof relative to the first housing portion 106A. Once aligned properly relative to the first housing portion 106A, the projection 150 can deflect towards an unbiased state and the engagement structure 154 can retain the second sleeve portion 136B at the desired location within the adapter 100. In an embodiment, the second sleeve portion 136A can include a plurality of latches 148, such as two latches spaced apart from one another on the sled 142.

FIG. 6 illustrates a bottom view of the first housing portion 106A and the second sleeve portion 136B being introduced therewith. In an embodiment, the first and second ports 108 and 110 can be separated by a sidewall 198. The sidewall 198 can define a gap 200. The gap 200 can have a dimension corresponding to a dimension of the sled 142 such that the second sleeve portion 136B can be inserted into the first housing portion 106A at a location where the sled 142 is aligned with the gap 200. As the second sleeve portion 136B is translated toward the first housing portion 106A, the latches 148 of the second sleeve portion 136B can interface with latch receivers, e.g., slots 202 of the first housing portion 106A to lock the second sleeve portion 136B on the first housing portion 106A. In certain instances, the gap 200 can have a depth that is the same as a corresponding height of the sled 142 such that an exposed portion of the sled 142 is flush with the bottom side 120 of the first housing portion 106A.

Referring again to FIG. 4, the internal structure can further include a shutter 156 at least partially disposed within the internal volume 140 to selectively block at least one of the ports, e.g., one of the first or second ports 108 or 110, and prevent ingress of debris into the port(s) when no optical cable is present therein. As depicted in FIG. 4, the shutter 156 can include a plurality of shutters, such as a first shutter 156A and a second shutter 156B. The number of shutters may equal the number of ports in the adapter 100. The plurality of shutters can further include complementary shutters 156C and 156D disposed on the other end (e.g., the second end 104) of the adapter 100 to block the complementary port on the other end of the adapter 100.

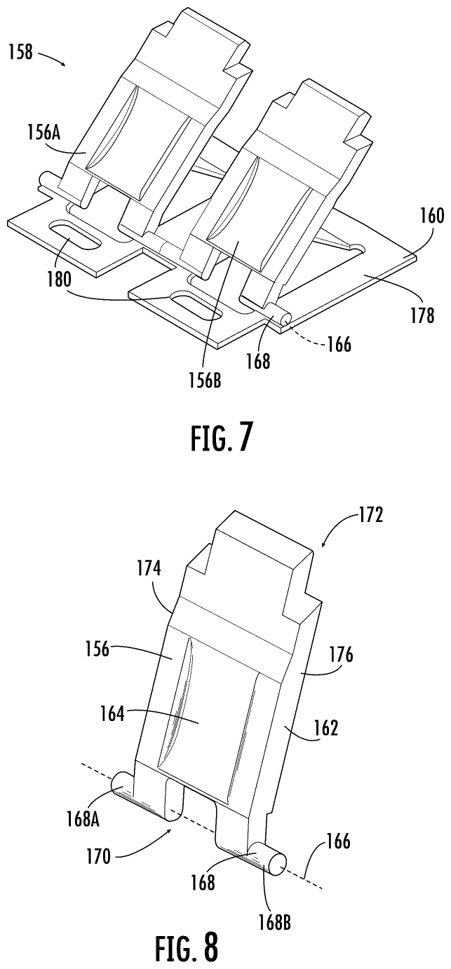

FIG. 7 illustrates an exemplary embodiment of a shutter structure 158 including the first and second shutters 156A and 156B and a biasing element 160 that biases the shutter structure 158, e.g., the first and second shutters 156A and 156B, to a closed position whereby debris is prevented from entering the internal volume 140 (FIG. 4) when optical cables are not present in the ports.

FIG. 8 illustrates one of the shutters 156 in accordance with an embodiment. The shutter 156 generally includes a body 162 defining a scalloped recess 164 configured to receive a leading edge of the optical cable or a connector coupled therewith when the optical cable is installed in the port of the adapter 100. The scalloped recess 164 can define an arcuate recess extending from a major surface of the body 162. As the leading edge of the optical cable or connector is pushed into the port, the leading edge can rest at least partially within the scalloped recess 164 and cause the shutter 156 to rotate about a rotational axis 166. The rotational axis 166 can be formed by an axle 168 disposed at a first end 170 of the body 162. In an embodiment, the axle 168 can be integrally formed with the body 162. The axle 168 may further be split between two or more elements, such as two portions 168A and 168B projecting from the body 162. In certain instances, a second end 172 of the body 162 can define a shape to form a close fit with an internal shape of the port defined in the first housing portion 106A. Similarly, opposite sidewalls 174 and 176 of the body 162 can have a suitable shape to block access to the port when the optical cables are not present therein. By way of non-limiting example, the opposite sidewalls 174 and 176 can have straight sidewalls.

Referring again to FIG. 7, at least one of the first and second shutters 156A or 156B can rest on the biasing element 160. For example, the axle 168 can rest directly on the biasing element 160 or be spaced apart from the biasing element 160 by an intermediary member, such as a pad, a bearing surface, or the like. In an embodiment, the rotational axis 166 remains at a relatively fixed position relative to the biasing element 160 as the shutter 156 moves through its entire range of motion between the open and closed positions.

In an embodiment, each of the shutters 156, i.e., each of the first and second shutters 156A and 156B, can share a biasing element 160. That is, the biasing element 160 supporting the first and second shutters 156A and 156B can be a single structure. In another embodiment, the first and second shutters 156A and 156B can have separate biasing elements 160. The separate biasing elements 160 may be disposed adjacent to one another and can mimic a single structure.

The biasing element 160 may include a base 178 upon which the shutters 156, or at least one of the shutters 156, rest. The base 178 can include a retention feature 180 to prevent the biasing element 160 from moving relative to the housing 106. For example, the retention feature 180 can include a hole extending through the base 178. In an embodiment, the hole can have a non-rotationally reflective shape such as an ovular shape, a polygonal shape, or the like, to prevent the base 178 from rotating relative to the housing 106. Referring to FIG. 9, the housing 106, e.g., the first housing portion 106A can include a complementary retention feature 182 that interfaces with the retention feature 180 to prevent relative movement of the biasing element 160 and the housing 106. By way of non-limiting example, the complementary retention feature 182 can include a projection which extends from the first housing portion 106A. In an embodiment, the projection can extend from the bottom side 120 of the first housing portion 106A. In an embodiment, the base 178 can be disposed between the first housing portion 106A and the second housing portion 106B (represented in FIG. 9 by dashed lines). In an embodiment, the first housing portion 106A can include recessed features, such as recesses 184 which accept the base 178. The recesses 184 can have depths with a similar, or same, dimension as a thickness of the base 178. The base 178 can thus form a flush fit with the bottom side 120 of the first housing portion 106A (see also FIG. 10). In an embodiment, the complementary retention feature 182 can have a similar, or same, dimension so that the complementary retention feature 182 does not extend past the bottom side 120 of the first housing portion 106A. As a result, the second housing portion 106B can form a close fit with the bottom side 120 of the first housing portion 106A and the base 178 of the biasing element 160 can be retained between the first housing portion 106A and the second housing portion 106B.

In an embodiment, the biasing element 160 includes a finger 186 projecting from the base 178. The finger 186 can be integral with the base 178 and move relative to the base 178 along a length of the finger 186 or at a hinge 188.

FIG. 10 illustrates a cross-sectional view of the adapter 100 as seen along Line A-A in FIG. 9. As illustrated, the finger 186 projects upward from the base 178 at a relative angle α. In an embodiment, the relative angle α is at least 10°, such as at least 15°, such as at least 20°, such as at least 25°, such as at least 30°, such as at least 35°, such as at least 40°, such as at least 45°. The finger 186 of the biasing element 160 can have a length L to position the shutter 156 at a desirable location relative to the housing 106. As depicted in FIG. 10, the finger 186 has a length L and is angled at a relative angle α such that the second end 172 of the shutter 156 is disposed adjacent to, or even at, a complementary location 188 of the housing 106 to restrict entrance of debris into the port 108 or 110.

As the shutter 156 is moved from the closed position as illustrated in FIG. 10 to an open position in a direction indicated by arrow 190, the finger 186 of the biasing element 160 deflects, e.g., in a downward direction. Pressure is generated by the finger 186 onto the shutter 156 such that when the optical cable or connector is removed from the port 108 or 110, the shutter 156 returns to the closed position of FIG. 10. A leading end 192 of the finger 186 can have a curved profile to prevent binding during movement of the shutter 156. The leading end 192 can track along an internal side 194 of the shutter 156 during movement of the shutter 156.

The first housing portion 106A can include an engagement structure, such as a notch 196, to engage the axle 168 (FIG. 8) of the shutter 156. The axle 168 can be retained in the notch 196 to restrict the rotational axis 166 to a relatively same position with respect to the first housing portion 106A and thus the adapter 100. In this regard, biasing force generated by the biasing element 160 does not undesirably move the shutter 156 from a desired position relative to the adapter 100.

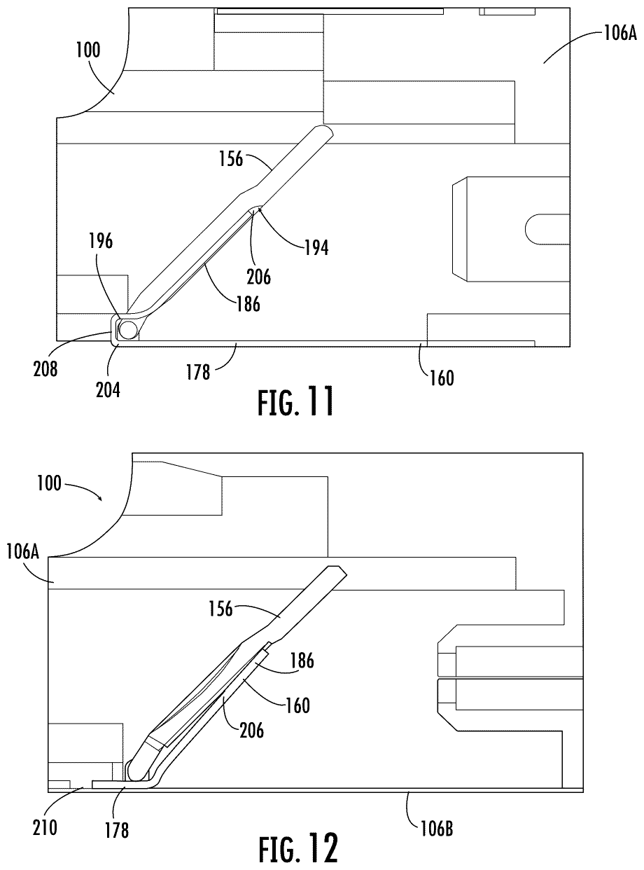

FIG. 11 illustrates an alternative embodiment of the adapter 100 as seen along Line A-A in FIG. 9. As depicted, the biasing element 160 includes a base 178 and finger 186 projecting from the base 178, however unlike the embodiment depicted in FIG. 10, the finger 186 projects from an end 204 of the base 178 and rests on the internal side 194 of the shutter 156. In an embodiment, the shutter 156 can have a recessed portion 206 in which the finger 186, or a portion thereof, rests within. An interface 208 between the base 178 and the finger 186 can form the notch 196, or be part of the notch 196, to retain the shutter 156 at the same relative position with respect to the first housing portion 106A.

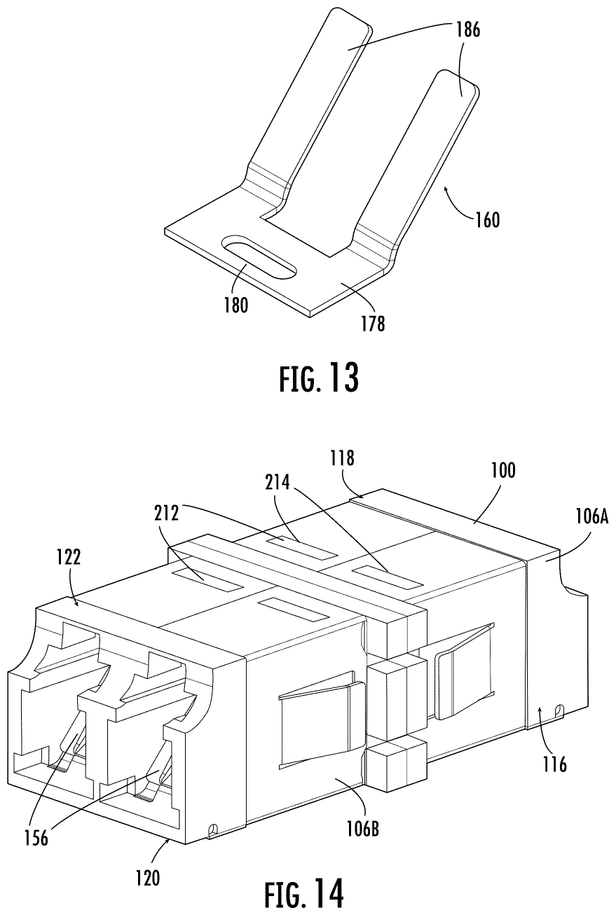

FIG. 12 illustrates yet another alternative embodiment of the adapter 100 as seen along Line A-A in FIG. 9 and FIG. 13 illustrates an embodiment of the biasing element 160 illustrated in FIG. 12. As depicted, the biasing element 160 includes a base 178 and a finger 186 projecting from the base, however unlike the embodiments depicted in FIGS. 10 and 11, the base 178 does not underlie the finger 186. Instead, the finger 186 is cantilevered from the base 178 and overhangs no portion of the base 178. The base 178 can be inserted into a slot 210 in the first housing portion 106A or between the first and second housing portions 106A and 106B to retain the base 178 and provide support to the finger 186. The finger 186 can be disposed within the recessed portion 206 of the shutter 156. Alternatively, the finger 186 can be embedded within the shutter 156, spaced apart from the shutter 156 by one or more intermediate elements, or coupled to the shutter 156 through a different type of interface. The base 178 can include the retention feature 180 to interface with the complementary retention feature 182 on the housing 106 to prevent the biasing element 160 from moving relative to the housing 106 when installed therewith.

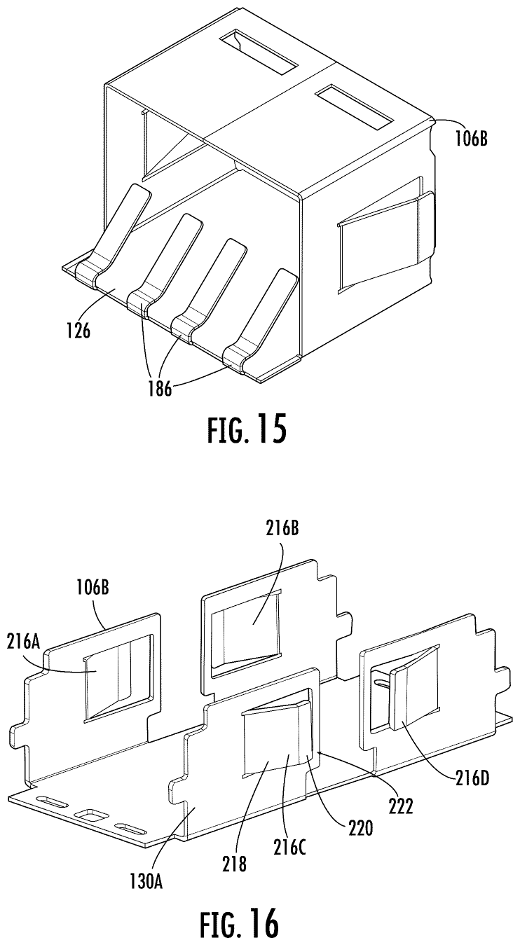

FIG. 15 illustrates yet another embodiment of a portion of the adapter 100. More particularly, FIG. 15 illustrates the second housing portion 106B integrally formed with the biasing element 160, or a portion thereof. The second housing portion 106B depicted in FIG. 15 is configured to extend around the entire first housing portion 106A. However, it should be understood that in certain instances, the second housing portion 106B depicted in FIG. 15 may not be required to extend around the entire first housing portion 106A. For example, the second housing portion 106B depicted in FIG. 15 can be disposed on at least portions of the first and second lateral sides 116 and 118 and the bottom side 120 of the first housing portion 106A.

The fingers 186 project from the bottom side 126 of the second housing portion 106B. Referring again to FIG. 14, the fingers 186 (FIG. 15) can be aligned with the shutters 156 when the second housing portion 106B is introduced to, e.g., translated towards, the first housing portion 106A.

As described above, the internal structure of the adapter 100 can be configured to receive, support and optically couple optical cables together to permit optical transmission therebetween. Described below is an exemplary system and method for attaching the adapter 100 to a structure, such as a frame, to allow an operator access to the adapter 100.

Referring again to FIG. 4 and FIG. 16, the second housing portion 106B is formed with one or more engagement structures, e.g., flanges 216, such as a first flange 216A, a second flange 216B, a third flange 216C and a fourth flange 216D. The first flange 216A can be disposed on the first segment 128A of the first lateral side 128 of the second housing portion 106B. The second flange 216B can be disposed on the second segment 128B of the first lateral side 128 of the second housing portion 106B. The third flange 216C can be disposed on the first segment 130A of the second lateral side 130 of the second housing portion 106B. The fourth flange 216D can be disposed on the second segment 130B of the second lateral side 130 of the second housing portion 106B. Yet other configurations are contemplated herein. For instance, one or both of the first or second lateral sides 128 or 130 can include a single structure in lieu of first and second portions where the single structure includes two flanges, etc.

In an embodiment, the flanges 216A, 216B, 216C and 216D can all share a generally same shape as one another. For instance, referring to FIG. 16, the third flange 216C can include a canted portion 218 extending away from the first segment 130A of the second lateral side 130 of the second housing portion 106B. The canted portion can form a relative angle, as measured with respect to the first segment 130A, of at least 5°, such as at least 10°, such as at least 15°, such as at least 20°, such as at least 25°, such as at least 30°. The relative angle of the canted portion 218 can cause the third flange 216C to project outward from the first segment 130A. A terminal segment 220 of the third flange 216C can be angled with respect to the canted portion 218. For instance, the terminal segment 220 can be angled at the same relative angle with respect to the canted segment 218 as the canted segment 218 is angled with respect to the first segment 130A. In this regard, the terminal segment 220 can be parallel with the first segment 130A of the second housing portion 106B. The terminal segment 220 can define an end surface 222 configured to form a stop feature to secure the adapter 100 relative to a structure, such as the aforementioned frame.

In certain instances, all of the flanges 216A, 216B, 216C and 216D can share a common shape, size, or both a common shape and a common size. In an embodiment, at least one of the flanges 216A, 216B, 216C or 216D can have a different shape as compared to another one of the flanges 216A, 216B, 216C or 216D. In yet another embodiment, at least one of the flanges 216A, 216B, 216C or 216D can have a different size as compared to another one of the flanges 216A, 216B, 216C or 216D.

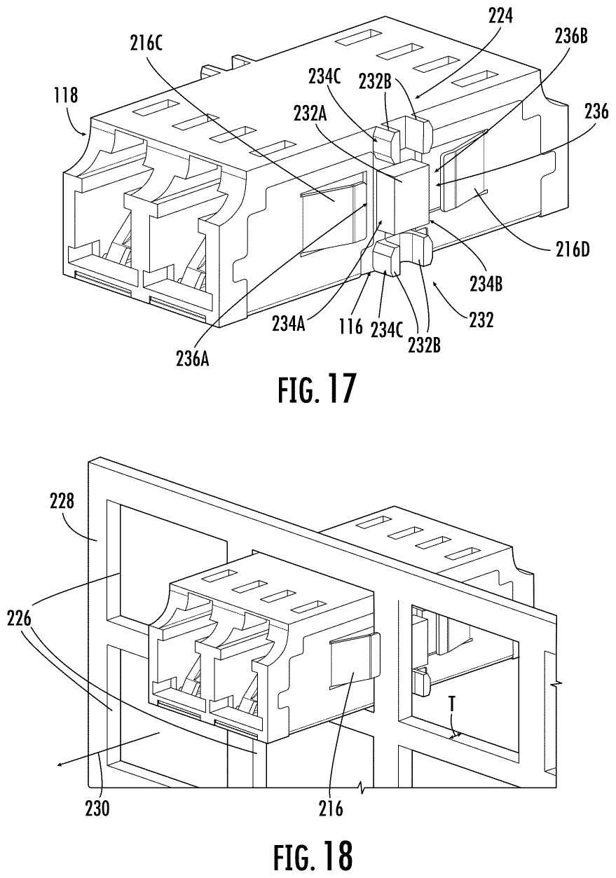

Referring to FIGS. 17 to 19, the flanges 216, in combination with stop features 224 of the housing 106, allow an installation technician to install the adapter 100 into a receiving slot 226, e.g., of a frame 228. The frame 228 can be part of a fiber network solution, e.g., a server space, a panel assembly, an in-field unit, etc. By translating the adapter 100 into the receiving slot 226 in a direction 230 (FIG. 18) until end surfaces 222 of at least one of the flanges 216 reaches the frame 228, the combination of flanges 216 and stop features 224 can serve to retain the adapter on the frame 228 such that the installation technician, or another technician at a later date, can install optical fibers into the ports 108 or 110 (FIG. 4) to optically couple one or more pairs of optical cables together.

In an embodiment, the stop features 224 are part of the first housing portion 106A. The stop features 224 can include one or more projections 232 that project away from the first and second lateral sides 116 and 118 of the first housing portion 106A.

For example, a first projection 232A can be a double-sided projection defining a first stop face 234A and a second stop face 234B. The first and second stop faces 234A and 234B can be disposed on opposite sides of the first projection 232A. Each of the first and second stop faces 234A and 234B can act in concert with a different one of the flanges 216, e.g., the third and fourth flanges 216C and 216D, respectively, to retain the adapter 100 in the receiving slot 226. A space 236 between the end surface 222 of each flange 216 and the respective stop face 234A or 234B of the first projection 232A can be sized to correspond with a dimension of the frame 228. For example, the frame 228 can define a thickness T that fits within the space 236B.

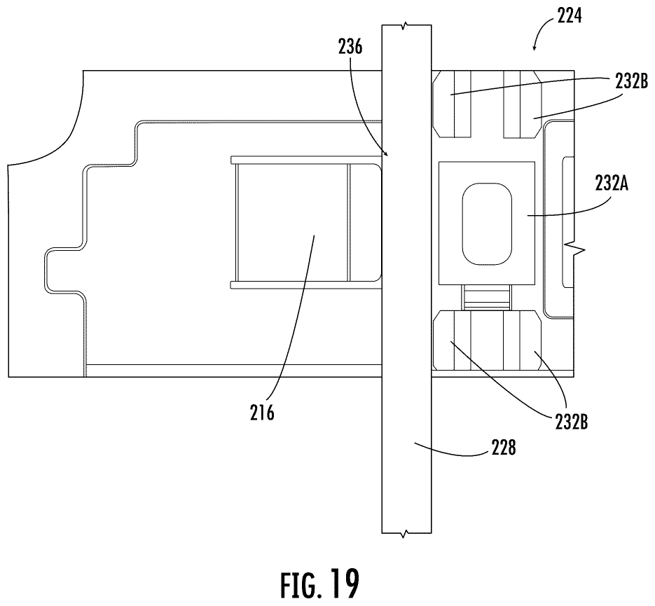

A second projection 232B can be a single-sided projection defining a single stop face 234C. The stop face 234C can act in concert with one of the flanges 216, e.g., the third or fourth flange 216C or 216D, to retain the adapter 100 in the receiving slot 226. In an embodiment, the stop face 234C of the second projection 232B can be parallel with, or substantially parallel with the first stop face 234A of the first projection 232A. Moreover, the stop face 234C can be colinear with the first stop face 234A of the first projection 232A such that both stop faces 234A and 234C. contact the frame 228, or at least align with the frame 228, when the frame 228 is disposed in the space 236, i.e., the adapter 100 is retained at the frame 228. Alternatively, the stop faces 234 can be offset from one another. For example, as illustrated in FIG. 19, the first stop face 234A can be offset from the frame 228 when the stop face 234C of the second projection 232B is abutting the frame 228. As such, the first projection 232A can form a safety stop in the event the second projection 232B breaks. The second projection 232A can also provide a user grip, allow for the use of deflecting first projections 232B while still providing a positive stop, i.e., the first projection 232A can be a rigid projection while the second projection(s) are deformable projections, or provide one or more additional benefits.

In an embodiment, the second projection 232B can include a plurality of second projections. The second projections 232B can act together, or separately, in various combinations to define the space 236 for receiving the frame 228. For instance, by way of non-limiting example, two second projections 232B can act in concert with the third flange 216C to define a first space 236A and two different second projections 232B can act in concert with the fourth flange 216D to define a second space 236B.

When the installation technician inserts the adapter 100 in direction 230 into the receiving slot 226, the first flange(s) 216 to contact the frame 228 deflect inward under force provided by the frame 228 to allow the adapter 100 to fit within the receiving slot 226. As the adapter 100 is further inserted into the receiving slot 226, the adapter 100 arrives at a position whereat the frame 228 is located at the space 236 defined by the flange(s) 216 and the projections 232. At this position, the flange(s) 216 are no longer biased by the frame 228 and return to their unbiased state. In their unbiased state, the end surface(s) 222 of the flange(s) 216 act in concert with the stop faces 234 of the projections 232 to retain the frame 228 within the space 236 and thereby retain the adapter 100 coupled with the frame 228.

Due to the inclusion of oppositely arranged flanges 216, i.e., the third flange 216C on a first side of the projections 232 and the fourth flange 216D on a second opposite side of the projections 232 and/or the first flange 216A on the first side of the projection 232 and the second flange 216B on the second opposite side of the projections 232, the adapter 100 can be reversible. That is, the adapter 100 can be installed into the receiving slots 226 of the frame 228 in a first orientation with the first port 108 facing toward the frame 228 during installation or a second orientation with the first port 108 facing away from the frame during installation. Moreover, the adapter 100 may be installed with either one of the bottom surface or the top surface 120 or 122 of the first housing portion 106A facing upward or downward. In this regard, the adapter 100 can be selectively installed on the frame 228 in a desirable configuration based on the individual needs of a particular installation requirement.

To release the adapter 100 from the frame 228, the flange(s) 216 forming the active space 236, i.e., the space 236 in which the frame 228 resides, are deflected inward until the end surface(s) 222 are clear of the frame 228. The adapter 100 is then translated through the receiving slot 226 until clear of the frame 228. Once translation of the adapter 100 is initiated, the flange(s) 216 may not require active pressure by the technician to maintain the flange(s) 216 in the depressed state as the frame 228 provides pressure thereagainst. Once removed from the frame 228, the flanges are in the unbiased state and the adapter 100 is again ready to be installed in the same, or another, receiving slot 226.

Further aspects of the invention are provided by one or more of the following embodiments:

Embodiment 1. An adapter comprising: a housing defining a pair of ports configured to optically couple together a first connector and a second connector, wherein the housing comprises: a first housing portion; and a second housing portion removably coupled to the first housing portion; a shutter coupled to the housing, wherein the shutter is movable between a closed position in which the first port is blocked and an open position in which the first port is accessible; and a biasing element biasing the shutter to the closed position, wherein a portion of at least one of the shutter and the biasing element is retained between the first and second housing portions.

Embodiment 2. The adapter of any one or more of the embodiments, wherein the first housing portion comprises a first material, wherein the second housing portion comprises a second material, and wherein the second material is different than the first material.

Embodiment 3. The adapter of any one or more of the embodiments, wherein the biasing element comprises: a base; a finger projecting from the base and elastically supporting the shutter, wherein the base comprises a retention feature and the housing comprises a complementary retention feature, and wherein the retention feature and the complementary retention feature interface with one another to prevent relative movement of the biasing element and the housing when the first and second housing portions are coupled together.

Embodiment 4. The adapter of any one or more of the embodiments, wherein the second housing portion and biasing element are both removable from the first housing portion by movement in a same direction.

Embodiment 5. The adapter of any one or more of the embodiments, wherein the second housing portion is disposed on at least three sides of the first housing portion when the first and second housing portions are coupled together, wherein the at least three sides include a bottom side, a first lateral side, and a second lateral side, and wherein the second housing portion includes a first flange extending outward from the first lateral side and a second flange extending outward from the first lateral side.

Embodiment 6. The adapter of any one or more of the embodiments, wherein the second housing portion further comprises a third flange extending outward from the second lateral side and a fourth flange extending outward from the second lateral side.

Embodiment 7. The adapter of any one or more of the embodiments, wherein the first housing further comprises a projection, and wherein the adapter is configured to be retained at a receiving cutout of a frame by the projection in combination with the first flange or the second flange.

Embodiment 8. The adapter of any one or more of the embodiments, wherein the adapter further comprises a ferrule sleeve disposed between and optically coupling together the first and second ports, and wherein the ferrule sleeve comprises a first sleeve portion integral with the first housing portion, and a second sleeve portion removably coupled with the first housing portion.

Embodiment 9. The adapter of any one or more of the embodiments, wherein the second sleeve portion comprises a latch interfaceable with the first housing portion to selectively couple the second sleeve portion to the first housing portion.

Embodiment 10. An optical system comprising: a frame having a first side and a second side, the frame defining a receiving slot extending between the first side and the second side; and an adapter comprising: a housing defining a pair of ports including a first port and a second port; a shutter coupled to the housing, wherein the shutter is movable between a closed position in which the first port is blocked and an open position in which the first port is accessible; and a biasing element biasing the shutter to the closed position, wherein the adapter is installable into the receiving slot from the first side of the frame in a first orientation with the first port facing toward the frame during installation or a second orientation with the first port facing away from the frame during installation, and wherein the adapter is selectively securable in the receiving slot in both the first and second orientations.

Embodiment 11. The optical system of any one or more of the embodiments, wherein the housing comprises a first housing portion and a second housing portion, wherein the second housing portion is disposed on at least three sides of the first housing portion when the first and second housing portions are coupled together, wherein the at least three sides include a bottom side, a first lateral side, and a second lateral side, wherein the second housing portion includes a first flange extending outward from the first lateral side, a second flange extending outward from the first lateral side, a third flange extending outward from the second lateral side and a fourth flange extending outward from the second lateral side, and wherein the first and third flanges or the second and fourth flanges interface with the frame to couple the adapter to the frame based on whether the adapter is in the first orientation or the second orientation.

Embodiment 12. The optical system of any one or more of the embodiments, wherein the adapter is further installable to the receiving slot from the second side of the frame in the first orientation or in the second orientation.

Embodiment 13. The optical system of any one or more of the embodiments, wherein a portion of both the shutter and the biasing element are retained between the first and second housing portions.

Embodiment 14. The optical system of any one or more of the embodiments, wherein the biasing element comprises: a base; a finger projecting from the base and elastically supporting the shutter, wherein the base comprises a retention feature and the housing comprises a complementary retention feature, and wherein the retention feature and the complementary retention feature interface with one another to prevent relative movement of the biasing element and the housing when the first and second housing portions are coupled together.

Embodiment 15. The optical system of any one or more of the embodiments, wherein the shutter comprises an axle extending into a notch in the housing, and wherein the notch is configured to maintain a rotational axis of the axle at a relatively same position with respect to the housing.

Embodiment 16. The optical system of any one or more of the embodiments, wherein the adapter further comprises a ferrule sleeve, wherein the ferrule sleeve comprises a first sleeve portion and a second sleeve portion, wherein the first sleeve portion is integral with the housing, and wherein the second sleeve portion is coupled to the housing by a latch.

Embodiment 17. The optical system of any one or more of the embodiments, wherein the first housing portion comprises a projection, wherein the second housing portion comprises a deformable flange, and wherein a space is defined between the projection and the flange, the space configured to receive the frame and retain the adapter relative to the frame.

Embodiment 18. A method of coupling an adapter to a frame defining a receiving slot, the method comprising: aligning the adapter including a shutter with the receiving slot in a first orientation or a second orientation opposite the first orientation; and translating the adapter into the receiving slot until the adapter passes a locking position after which removal of the adapter from the receiving cutout requires an unlocking procedure.

Embodiment 19. The method of any one or more of the embodiments, wherein the shutter is installed in the adapter prior to aligning the adapter with the receiving slot, and wherein installing the shutter in the adapter comprises translating the shutter into the adapter in a direction generally perpendicular to a direction of translating the adapter into the receiving slot.

Embodiment 20. The method of any one or more of the embodiments, wherein the adapter comprises a first housing portion and a second housing portion coupled together, and wherein installing the shutter into the adapter comprises coupling the second housing portion with the first housing portion after translating the shutter into the adapter.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An adapter comprising:
a housing defining a pair of ports configured to optically couple together a first connector and a second connector, wherein the housing comprises:
a first housing portion; and
a second housing portion removably coupled to the first housing portion;
a shutter coupled to the housing, wherein the shutter is movable between a closed position in which the first port is blocked and an open position in which the first port is accessible; and
a biasing element biasing the shutter to the closed position,
wherein a portion of at least one of the shutter and the biasing element is retained between the first and second housing portions.

2. The adapter of claim 1, wherein the first housing portion comprises a first material, wherein the second housing portion comprises a second material, and wherein the second material is different than the first material.

3. The adapter of claim 1, wherein the biasing element comprises:
a base;
a finger projecting from the base and elastically supporting the shutter,
wherein the base comprises a retention feature and the housing comprises a complementary retention feature, and wherein the retention feature and the complementary retention feature interface with one another to prevent relative movement of the biasing element and the housing when the first and second housing portions are coupled together.

4. The adapter of claim 1, wherein the second housing portion and biasing element are both removable from the first housing portion by movement in a same direction.

5. The adapter of claim 1, wherein the second housing portion is disposed on at least three sides of the first housing portion when the first and second housing portions are coupled together, wherein the at least three sides include a bottom side, a first lateral side, and a second lateral side, and wherein the second housing portion includes a first flange extending outward from the first lateral side and a second flange extending outward from the first lateral side.

6. The adapter of claim 5, wherein the second housing portion further comprises a third flange extending outward from the second lateral side and a fourth flange extending outward from the second lateral side.

7. The adapter of claim 5, wherein the first housing further comprises a projection, and wherein the adapter is configured to be retained at a receiving cutout of a frame by the projection in combination with the first flange or the second flange.

8. The adapter of claim 1, wherein the adapter further comprises a ferrule sleeve disposed between and optically coupling together the first and second ports, and wherein the ferrule sleeve comprises a first sleeve portion integral with the first housing portion, and a second sleeve portion removably coupled with the first housing portion

9. The adapter of claim 8, wherein the second sleeve portion comprises a latch interfaceable with the first housing portion to selectively couple the second sleeve portion to the first housing portion.

10. An optical system comprising:
a frame having a first side and a second side, the frame defining a receiving slot extending between the first side and the second side; and
an adapter comprising:
a housing defining a pair of ports including a first port and a second port;
a shutter coupled to the housing, wherein the shutter is movable between a closed position in which the first port is blocked and an open position in which the first port is accessible; and
a biasing element biasing the shutter to the closed position,
wherein the adapter is installable into the receiving slot from the first side of the frame in a first orientation with the first port facing toward the frame during installation or a second orientation with the first port facing away from the frame during installation, and
wherein the adapter is selectively securable in the receiving slot in both the first and second orientations.

11. The optical system of claim 10, wherein the housing comprises a first housing portion and a second housing portion, wherein the second housing portion is disposed on at least three sides of the first housing portion when the first and second housing portions are coupled together, wherein the at least three sides include a bottom side, a first lateral side, and a second lateral side, wherein the second housing portion includes a first flange extending outward from the first lateral side, a second flange extending outward from the first lateral side, a third flange extending outward from the second lateral side and a fourth flange extending outward from the second lateral side, and wherein the first and third flanges or the second and fourth flanges interface with the frame to couple the adapter to the frame based on whether the adapter is in the first orientation or the second orientation.

12. The optical system of claim 10, wherein the adapter is further installable to the receiving slot from the second side of the frame in the first orientation or in the second orientation.

13. The optical system of claim 10, wherein a portion of both the shutter and the biasing element are retained between the first and second housing portions.

14. The optical system of claim 10, wherein the biasing element comprises:
a base;
a finger projecting from the base and elastically supporting the shutter,
wherein the base comprises a retention feature and the housing comprises a complementary retention feature, and wherein the retention feature and the complementary retention feature interface with one another to prevent relative movement of the biasing element and the housing when the first and second housing portions are coupled together.

15. The optical system of claim 10, wherein the shutter comprises an axle extending into a notch in the housing, and wherein the notch is configured to maintain a rotational axis of the axle at a relatively same position with respect to the housing.

16. The optical system of claim 10, wherein the adapter further comprises a ferrule sleeve, wherein the ferrule sleeve comprises a first sleeve portion and a second sleeve portion, wherein the first sleeve portion is integral with the housing, and wherein the second sleeve portion is coupled to the housing by a latch.

17. The optical system of claim 10, wherein the first housing portion comprises a projection, wherein the second housing portion comprises a deformable flange, and wherein a space is defined between the projection and the flange, the space configured to receive the frame and retain the adapter relative to the frame.

18. A method of coupling an adapter to a frame defining a receiving slot, the method comprising:
aligning the adapter including a shutter with the receiving slot in a first orientation or a second orientation opposite the first orientation; and
translating the adapter into the receiving slot until the adapter passes a locking position after which removal of the adapter from the receiving cutout requires an unlocking procedure.

19. The method of claim 18, wherein the shutter is installed in the adapter prior to aligning the adapter with the receiving slot, and wherein installing the shutter in the adapter comprises translating the shutter into the adapter in a direction generally perpendicular to a direction of translating the adapter into the receiving slot.

20. The method of claim 19, wherein the adapter comprises a first housing portion and a second housing portion coupled together, and wherein installing the shutter into the adapter comprises coupling the second housing portion with the first housing portion after translating the shutter into the adapter.
